(19) United States
(12) Patent Application Publication
(10) Pub. No.: US 2006/0187568 A1
(43) Pub. Date: Aug. 24, 2006

(54) System and method to optimize track spacing on a rotatable media

(75) Inventor: Joseph T. Castagna, San Jose, CA (US)

Correspondence Address: FLIESLER MEYER, LLP, FOUR EMBARCADERO CENTER, SUITE 400, SAN FRANCISCO, CA, 94111, US

(73) Assignee: Matsushita Electric Industrial Co., Ltd., Osaka (JP)

(21) Appl. No.: 11/062,049

(22) Filed: Feb. 18, 2005

(51) Int. Cl. G11B 21/02

(52) U.S. Cl. 360/75

(57) ABSTRACT

Methods in accordance with embodiments of the present invention can be applied to self-servo write a disk in a hard disk drive device having a ramp positioned near an outer diameter of the disk. In one such embodiment, a first user track can be assigned based on an acquire track such that a conservative buffer exists between the first user track and the acquire track, thereby avoiding damage to the disk surface. A first portion of a data region can be defined between the first user track and a track near an inner diameter. A second portion of the data region can be defined between a track near the ramp, such as the acquire track, and the first user track. Servo tracks can be self-servo written across the first and second portions, and critical system information can subsequently be written to the first portion.

### TECHNICAL FIELD

The present invention relates to rotatable media data storage devices, as for example optical or magnetic hard disk drive technology.

### BACKGROUND

A hard disk drive typically contains one or more disks clamped to a rotatable spindle motor, at least one head for reading data from and/or writing data to the surfaces of each disk, and an actuator utilizing linear or rotary motion for positioning the head(s) over selected data tracks on the disk(s). The actuator positions the read/write head over the surface of the disk as the spindle motor rotates and spins the disk.

As the head is loaded onto a disk, for example from a ramp, the servo system determines the position of the head on the disk surface by reading servo wedges passing beneath the head. A first track identified by the servo system as the head unloads from the ramp is identified as an acquire track. A first user track can be assigned based on the position of the acquire track, and can define an outer boundary of a data region. The acquire track is some small distance from the ramp, and farther from the outer diameter of the disk than is optimal or desired, wasting otherwise usable space and requiring an increased track density for a given hard disk drive capacity.

### BRIEF DESCRIPTION OF THE FIGURES

Further details of embodiments of the present invention are explained with the help of the attached drawings in which:

FIG. 1 is a partial exploded view of an exemplary hard disk drive for applying a spindle motor and method in accordance with one embodiment of the present invention;

FIG. 2 is a close-up view of a head suspension assembly used in the hard disk drive of FIG. 1, showing head, slider and suspension;

FIG. 3 is a perspective view of the motion of the rotary actuator of FIG. 1 unloading the head from the disk;

FIG. 4 is a side view of the head suspension assembly as the head is loaded onto the disk from the ramp; and

FIG. 5 is a flowchart of a method in accordance with one embodiment of the present invention to self servo write a disk surface.

### DETAILED DESCRIPTION

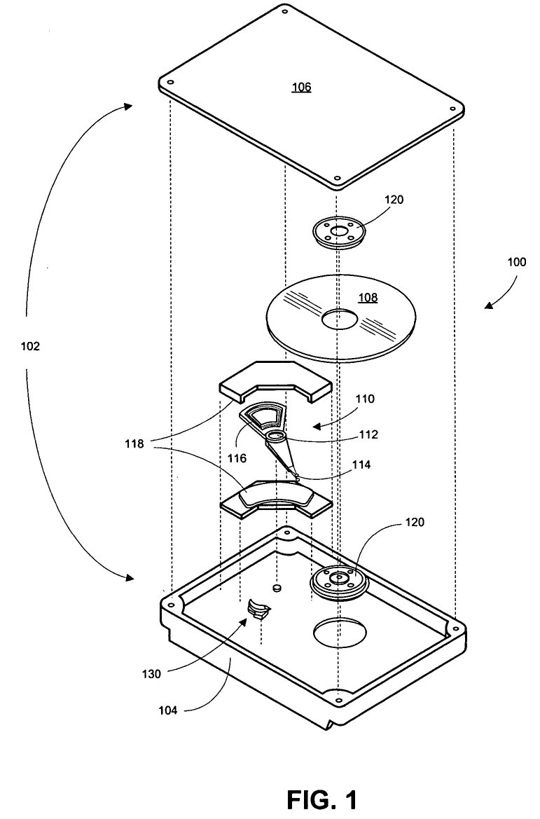

FIG. 1 is an exploded view of an exemplary hard disk drive 100 for applying a method in accordance with one embodiment of the present invention. The hard disk drive 100 includes a housing 102 comprising a housing base 104 and a housing cover 106. The housing base 104 illustrated is a base casting. Alternatively, the housing base 104 can comprise separate components assembled prior to, or during assembly of the hard disk drive 100. A spindle 120 is connected with the housing base 104. A disk 108 is attached to the spindle 120, for example by clamping. The disk 108 can be made of a light aluminum alloy, ceramic/glass or other suitable substrate, with magnetizable material deposited on one or both sides of the disk 108. The magnetic layer has tiny domains of magnetization for storing data transferred through heads 114. In an embodiment, the head 114 is a magnetic transducer adapted to read data from the disk 108 and write data to the disk 108. The disk 108 can be rotated at a constant or varying rate typically ranging from less than 3,600 to more than 15,000 RPM (speeds of 4,200 and 5,400 RPM are common in hard disk drives designed for mobile devices such as laptop computers). The invention described herein is equally applicable to technologies using other media, as for example, optical media. Further, the invention described herein is equally applicable to devices having any number of disks 108 attached to the spindle 120. In other embodiments, the head 114 includes a separate read element and write element. For example, the separate read element can be a magneto-resistive head, also known as an MR head. It will be understood that multiple head 114 configurations can be used.

A rotary actuator 110 is pivotally mounted to the housing base 104 by a bearing 112 and sweeps an arc between an inner diameter (ID) of the disk 108 and a ramp 130 optionally positioned near an outer diameter (OD) of the disk 108. Attached to the housing 104 are upper and lower magnet return plates 118 and at least one magnet that together form the stationary portion of a voice coil motor (VCM). A voice coil 116 is mounted to the rotary actuator 110 and positioned in an air gap of the VCM. The rotary actuator 110 pivots about the bearing 112 when current is passed through the voice coil 116 and pivots in an opposite direction when the current is reversed, allowing for precise positioning of the head 114 along the radius of the disk 108. Each side of a disk 108 can have an associated head 114, and the heads 114 are collectively coupled to the rotary actuator 110 such that the heads 114 pivot in unison. The invention described herein is equally applicable to devices wherein the individual heads separately move some small distance relative to the actuator. This technology is referred to as dual-stage actuation (DSA).

The VCM is coupled with a servo system (not shown) that uses positioning data read by the head 114 from the disk 108 to determine the position of the head 114 over tracks on the disk 108. One type of servo system is a sectored, or embedded, servo system in which tracks on the disk 108 surfaces contain small segments of servo data often referred to as servo wedges or servo sectors. Each track can contain an equal number of servo wedges, spaced relatively evenly around the circumference of the track. Hard disk drive designs have been proposed having different numbers of servo wedges on different tracks, and such hard disk drive designs could also benefit from the invention contained herein.

Servo wedges can be written to the disk 108 using a media writer, prior to assembly of the hard disk drive 100. Stacks of disks 108 can be loaded onto the media writer and servo wedges can be carefully written onto each disk 108 surface, a time consuming and costly process. Alternatively, a commonly less time-consuming and less expensive method can include writing servo wedges or template patterns on a reference surface of a single blank disk to be used as a reference for self-servo writing unwritten (and written) surfaces of one or more disks 108 of an assembled hard disk drive 100.

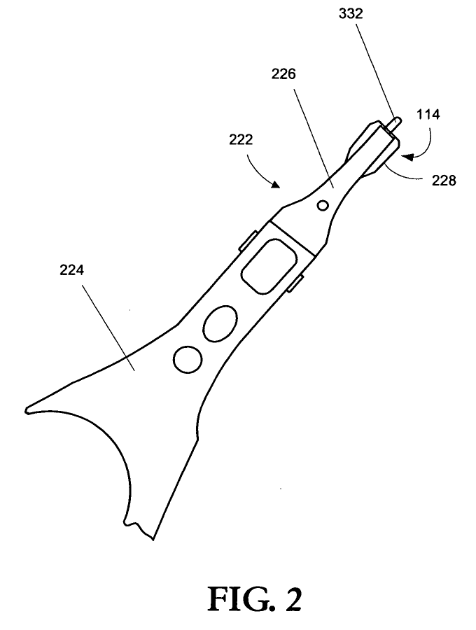

FIG. 2 details an example of a subassembly commonly referred to as a head suspension assembly (HSA) 222 comprising the head 114 formed on a slider 228, which is further connected with a flexible suspension member (also referred to herein as a suspension) 226. The suspension 226 can be connected with an arm 224 which in an embodiment can be either integrally formed with a mount for a bearing 112 or separately attached to the mount. The head 114 can be formed on the slider 228 using a number of different techniques, for example the head 114 and slider 228 can be manufactured on a single die using semiconductor processing (e.g. photolithography and reactive ion etching). Spinning of the disk 108 increases air pressure beneath the slider 228, creating a thin air bearing that lifts the slider 228 (and consequently the head 114) off of the surface of the disk 108. A micro-gap of typically less than one micro-inch can be maintained between the disk 108 and the head 114 in an embodiment. The suspension 226 can be bent or shaped to act as a spring such that a force is applied to the disk 108 surface. The air bearing resists the spring force applied by the suspension 226 and the opposition of the spring force and the air bearing to one another allows the head 114 to trace the surface contour of the rotating disk 108 (which is likely to have minute warpage) without “crashing” against the disk 108 surface. As is well understood by those of ordinary skill in the art, not all heads ride an air bearing as described above. When a head 114 “crashes,” the head 114 collides with the disk 108 surface such that the head 114 and/or the disk 108 surface may be damaged.

Refinements in disk fabrication have enabled manufacturers to produce disks 108 having ultra-smooth surfaces. If the speed of rotation of the disk 108 slows such that the air bearing between the slider 228 and disk 108 collapses, the slider 228 can contact and stick to the surface of the disk 108, causing catastrophic failure of the hard disk drive 100. For example, sticking can cause the disk 108 to abruptly lock in position or sticking can cause the slider 228 to be forcibly disconnected from the suspension 226. Thus, when the hard disk drive 100 is not in use and rotation of the disks 108 is slowed and stopped (i.e., the disks 108 are “spun down”), the heads 114 can be removed from close proximity to the disk 108 surface by positioning the HSA 222 on a ramp 130 located either adjacent to the disk 108 or just over the disk 108 surface.

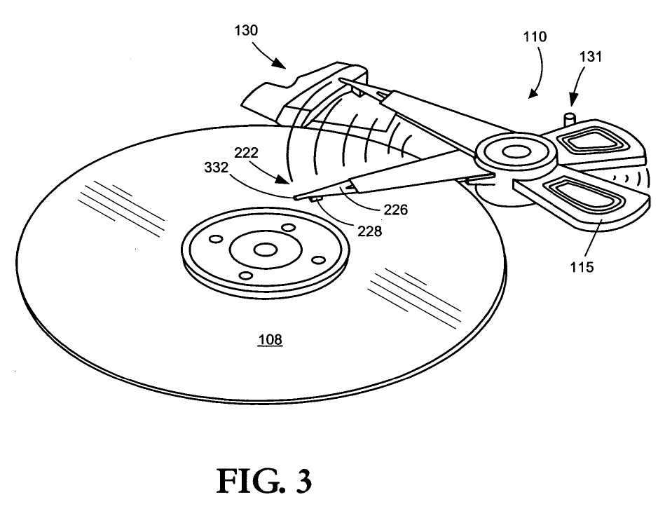

The slider 228 should be unloaded from the disk 108 before the air bearing between the slider 228 and the disk 108 collapses. FIG. 3 illustrates motion of the actuator 110 as the slider 228 is unloaded from the disk 108 and as the suspension 226 is driven up the ramp 130. The actuator 110 pivots from location 1, where the slider 228 is positioned over the disk 108 surface, to location 2, where the slider 228 is positioned adjacent to the disk 108. The range of motion of the actuator 130 is commonly referred to as a stroke. The slider 228 is removed from close proximity with the disk 108 by pivoting the actuator 110 such that a lift tab 332 extending from the suspension 226 contacts the ramp surface and slides up the ramp 130. The position along the ramp 130 where the lift tab 332 first contacts the ramp 130 can be called the touch-point. As the lift tab 332 slides up the ramp 130 from the touch-point, the ramp 130 opposes the spring force of the suspension 226 and forces the slider 228 (and the head 114) away from the disk 108 surface. The HSA 222 can continue its motion along the stroke by traveling up the grade portion of the ramp 130 to a substantially flat portion that optionally can include a detent for cradling the lift tab 332. The head 114 can be loaded back onto the disk 108 after the disk 108 spins up to a safe speed. In other embodiments, the HSA 222 contacts the ramp 130 at a location along the suspension 226 between the head 114 and the pivot point. Unloading the head 114 from the disk 108 prevents sticking, and further provides resistance to damage from non-operating shock by suspending the head 114 over a significantly wide gap between the head 114 and an opposing head or surface, rather than placing the head 114 in close proximity to the rigid disk 108 surface.

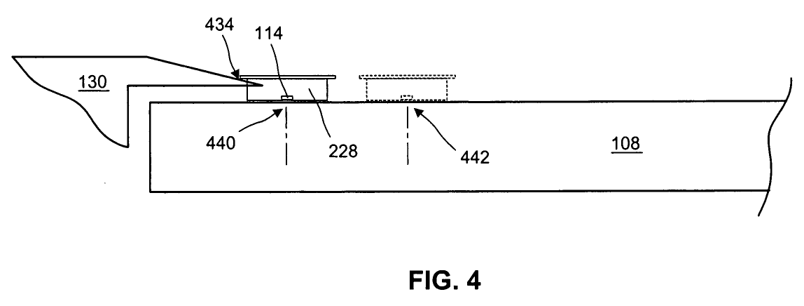

Referring to FIG. 4, as the slider 228 is loaded onto the disk 108 from the ramp 130 (pivoting from location 2 to location 1 in FIG. 3), the slider 228 can contact the disk 108 surface, possibly damaging one or both of the disk 108 surface and the slider 228. Frequent loading of the slider 228 from the ramp 130 to the disk 108 can cause damage that can be exacerbated by the type of media used. For example, where the disk 108 comprises glass media, scratches and other damage can be common over time. Such damage can interfere with performance of the head 114.

Once an air bearing develops, the head 114 determines its position on the disk 108 surface by reading servo wedges (or timing bursts of template patterns) passing beneath the head 114. Servo wedges read by the head 114 identify servo tracks on the disk 108 surface. (Timing bursts of template patterns can also be used to identify tracks on the disk 108 surface, and methods in accordance with the present invention should not be construed as being limited in applicability to disk 108 surfaces having resolved servo wedges.) The first track that the head 114 locks on can be identified as an acquire track 440. Ideally, the acquire track 440 is positioned in close proximity to the touch-point 434 of the ramp 130 so that a maximum amount of the stroke can be used for user data. However, more likely an acquire track 440 is some small distance from the ramp 130, and farther from the OD than is optimal or desired.

Variation between the maximum and minimum distance between the ramp 130 and the acquire track 440 can be attributed to myriad factors, including one or both of sampling error and load velocity. For example, in one such technique for assigning an acquire track 440, ten consecutive acceptable servo wedges must be measured before a track number is recorded as an acquire track 440. Further, as the head 114 is loaded onto the disk 108, the head 114 can enter the perimeter of the track just as a servo wedge is passing adjacent rather than directly beneath the head 114. The head 114 can continue to travel along the stroke toward the ID at a load velocity until the position of the head 114 can be sampled as the next servo wedge passes beneath the head 114. The sampling error and load velocity can result in a variation in the location of the acquire track 440 of several hundred tracks.

Typically, a first user track 442 defines an outer boundary of a data region and can be assigned to a track located some distance farther from the OD than the acquire track 440. The first user track 442 typically (though not necessarily) contains critical system information. Critical system information can include calibration data and/or other information identifying the hard disk drive 100, and is typically stored for the life of the hard disk drive 100. Loss of critical system information, for example due to physical damage, can essentially render the hard disk drive 100 unreadable and useless. Therefore, the distance between the first user track 442 and the acquire track 440 can act as a buffer so that the head 114 can avoid reading or writing to the disk 108 while traversing the portion of the disk 108 surface possibly damaged by the sporadic contact occurring during frequent loading of the slider 228 from the ramp 130 to the disk 108. In other embodiments, the first user track 442 can be assigned to a track further from the OD (for example at the ID), or critical system information can be written starting at a track other than the first user track 442. However, locating the first user track 442 and critical system information near the OD can provide performance advantages (for example, a higher rate of data transfer).

As mentioned above, contact between the slider 228 and the disk 108 typically occurs at the touch point 434 where the suspension lift tab 332 leaves the ramp 130. A conservative buffer, for example, locates the first user track 442 about one-and-a half widths of the slider 228 away from the acquire track 440 (as shown in FIG. 4). The acquire track 440 estimates the location of the touch-point 434 for purposes of setting the first user track 442; however, the average acquire track 440 is likely located some undesirable distance from the touch-point 434. Therefore, the buffer is likely farther from the OD than is necessary to avoid defects. Setting the first user track 442 based on the acquire track 440 can reduce the disk 108 surface available for user data. Typically, a manufacturer will increase the density of the tracks written to the disk 108 surface to produce a hard disk drive 100 having a targeted capacity. An increase in track density can negatively impact hard disk drive 100 performance, resulting, for example, in a reduction in manufacturing tolerance for the width of the head 114, or a degradation in the performance of the servo system.

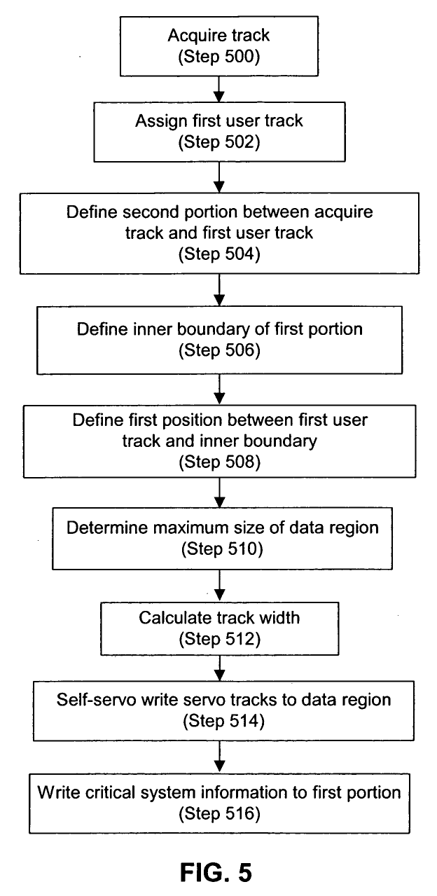

As shown in FIG. 5, a method to self-servo write a disk 108 surface in accordance with one embodiment of the present invention can include reducing a radial track density, or increasing a disk capacity for a given track density by storing data other than critical system information on a portion of a disk 108 having a higher risk of being physically damaged when the slider 228 is loaded to the disk 108. The method includes determining an acquire track 440 (Step 500) and locating a first user track 442 a distance away from an acquire track 440 such that any damage to the disk 108 surface caused by contact between the disk 108 surface and a slider 228 is likely traversed by the slider 228 before the head 114 is positioned over the first user track 442 (Step 502). For example, the distance can be a buffer of one-and-a-half slider 228 widths. The first user track 442 can define an outer boundary of a first portion of a data region. A second portion of the data region can be allocated for data other than critical system information (Step 504) and can have an outer boundary, for example, at an acquire track 442, or some other location nearer a ramp 130 than the first user track 442. The first user track 442 can define an inner boundary of the second portion. As the hard disk drive 100 is used, data is written such that disk capacity is filled from the outer boundary to an inner boundary of the first portion. As the disk 108 surface approaches capacity, with the innermost tracks filling with data, additional data can be stored in the second portion, which includes allocated tracks near the OD.

The inner boundary of the first portion can be defined by pivoting the rotary actuator 130 such that the head 114 moves towards the ID (Step 506). A number of cycles can be measured by the head 114 from the first user track 442 until the actuator 130 contacts an ID crash stop. The first portion can be determined by calculating the disk 108 surface available between the first user track 442 and the ID crash stop based on the number of cycle measured between the first user track 442 and the ID crash stop, and optionally deducting an ID buffer between the ID crash stop and an innermost user track (Step 508).

A maximum size of the data region can be determined by adding the first portion and the second portion of the data region (Step 510). Once the maximum disk 108 surface available for the data region is calculated, a width can be calculated for each track given a target capacity (Step 512). Alternatively the hard disk drive 100 capacity can be maximized for a given track density. As described above, the disk 108 surface included in the second portion can be susceptible to damage from contact with the slider 228 during loading of the head 114 to the disk 108. Data stored in the secondportiontherefore can have a higher risk of corruption or loss from ineffective writing or reading by the head 114. (For example, where the slider 228 traverses damage, a gap between the head 114 and the disk 108 surface can be increased such that the head 114 cannot communicate with the disk 108 surface.) In many applications, this risk can be acceptable. Further, the second portion may or may not be utilized during the hard disk drive's usable lifetime. For example, a user may only utilize 90% of a hard disk drive's capacity, and may never utilize the second portion. Increasing the usable disk 108 surface can improve the overall robustness of the hard disk drive 100 for a fixed disk capacity. As radial track density decreases, track width increases, improving performance of the servo system and head 114 and increasing manufacturing tolerance for the head 114 width.

The data region can be self-servo written such that tracks are assigned to the first portion consecutively, starting from the first user track 442 and moving toward the ID (Step 514). The second portion can be self-servo written such that tracks are assigned to the second portion consecutively, starting from the outermost track (e.g. the acquire track) and moving toward the first user track 442 (Step 516). In other embodiments, the second portion can be self-servo written such that tracks are assigned to the second portion consecutively, starting from the first user track 442 and moving toward the outermost track (e.g. the acquire track), thereby increasing the risk of traversing damage as later-written data is written or read from the second portion. In still other embodiments, track numbers need not be assigned consecutively. Critical system information is subsequently written to the first portion of the data region. In one embodiment the critical system information is written to outermost tracks of the first portion (Step 518).

Methods in accordance with the present invention can further be applied to self servo write a plurality of disks 108 or a plurality of disk 108 surfaces connected with a spindle motor 112. Where the actuator 110 is connected with a plurality of heads 114, an acquire track 440 can be identified by a first track locked on by any one of the plurality of heads 114. A first user track 442 can be assigned a distance away from the acquire track 440 as described above for each disk 108 surface such that when one of the plurality of heads 114 is positioned over the first user track 442, the others of the plurality of heads 114 are positioned over corresponding first user tracks 442. As described above, the rotary actuator 130 can then be pivoted such that the head 114 moves towards the ID, and a number of cycles can be measured by the head 114 until the actuator 130 contacts an ID crash stop. A first portion of the data region can be determined by calculating the disk 108 surface available between the first user track 442 and the ID crash stop based on the number of cycle measured between the first user track 442 and the ID crash stop, and optionally deducting an ID buffer between the ID crash stop and an innermost user track.

A second portion of the data region for each disk 108 surface can have an outer boundary at an outermost track (e.g. the acquire track 440) and an inner boundary at the first user track 442. A size of the data region can be the same for each disk 108 surface, and the maximum size of the data region can be determined by adding the first portion and the second portion. Once the maximum disk 108 surface available for the data region is calculated, a width can be calculated for each track given a target capacity. Alternatively the hard disk drive 100 capacity can be maximized for a given track density. The data region can be self-servo written for each disk 108 surface once the data track width is calculated.

The data region for each disk 108 surface can be self-servo written as described above, such that tracks are assigned to the first portion consecutively, starting from the first user track 442 and moving toward the ID. The second portion can be self-servo written such that tracks are assigned to the second portion consecutively, starting from the outermost track (e.g. the acquire track) and moving toward the first user track 442. In other embodiments, the second portion can be self-servo written such that tracks are assigned to the second portion consecutively, starting from the first user track 442 and moving toward the outermost track (e.g.. the acquire track), thereby increasing the risk of traversing damage as later-written data is written or read from the second portion. In still other embodiments, track numbers need not be assigned consecutively. Critical system information can be written to the first portion of at least one of the plurality of disk 108 surfaces such that critical system information is written to outermost tracks of the first portion. In one embodiment, a disk controller can prioritize tracks for each of the plurality of disk 108 surfaces so that data is written to the first portions of corresponding disk 108 surfaces before data is written to the second portion of any of the plurality of disk 108 surfaces.

The foregoing description of preferred embodiments of the present invention has been provided for the purposes of illustration and description. It is not intended to be exhaustive or to limit the invention to the precise forms disclosed. Many modifications and variations will be apparent to one of ordinary skill in the relevant arts. The embodiments were chosen and described in order to best explain the principles of the invention and its practical application, thereby enabling others skilled in the art to understand the invention for various embodiments and with various modifications that are suited to the particular use contemplated. It is intended that the scope of the invention be defined by the claims and their equivalence.

1. A method to self-servo write a rotatable medium in a data storage device having a ramp to remove a head from communication with the rotatable medium, the method comprising:
defining a first data region on the rotatable medium; and
defining a second data region on the rotatable medium, the second data region occupying a portion of the rotatable medium closer to an outer diameter of the rotatable medium than the first data region;
writing servo data for a plurality of user tracks such that the servo data are radially spaced across the first and second data regions;
writing critical system information to the first data region.

2. The method of claim 1, wherein defining a first data region on the rotatable medium further comprises:
positioning the head over the rotatable medium;
acquiring an acquire track from a plurality of servo tracks on the rotatable medium using the head;
assigning a first user track to one of the plurality of servo tracks located closer to an inner diameter of the rotatable medium than the acquire track such that a buffer exists between the first user track and the acquire track; and
defining the first portion such that the first user track is an outer boundary of the first portion.

3. The method of claim 2, wherein:
the head is connected with a slider having a slider width; and
the buffer is larger than the slider width.

4. The method of claim 3, wherein the buffer is one-and-a-half slider widths.

5. The method of claim 2, wherein defining the second portion further comprises defining the second portion such that the first user track is an inner boundary of the second portion.

6. The method of claim 1, wherein:
the head is connected with an actuator; and
the head is removed from communication with the rotatable medium by positioning the actuator on the ramp.

7. The method of claim 6, wherein positioning the head further comprises loading the head onto the rotatable medium by removing the actuator from contact with the ramp.

8. A system to self-servo write a rotatable medium in a data storage device, comprising:
a housing;
a bearing connected with the housing, the rotatable medium being connected with the bearing;
a ramp connected with the housing and arranged such that a portion of the ramp extends over an outer diameter of the rotatable medium;
an actuator pivotably connected with the housing;
a head operably associated with the actuator such that the head is positionable over the rotatable medium; and
a disk controller electrically connected with the head, the disk controller being adapted to perform the steps of:
positioning the head over the rotatable medium;
acquiring an acquire track from a plurality of servo tracks on the rotatable medium using the head;
assigning a first user track to one of the plurality of servo tracks located closer to an inner diameter of the rotatable medium than the acquire track such that a buffer exists between the first user track and the acquire track;
assigning an inner user track to one of the plurality of servo tracks located near an inner hard stop;
defining a first portion of a data region to be between the first user track and the inner user track;
defining a second portion of the data region to be between the acquire track and the first user track; and
writing servo data for a plurality of user tracks such that the servo data are radially spaced across the first and second portions.

9. The system of claim 8, wherein the disk controller is further adapted to perform the step of writing critical system information to the first portion.

10. The system of claim 8, wherein:
the head is associated with a slider having a slider width; and
the buffer is larger than the slider width.

11. The system of claim 10, wherein the buffer is one-and-a-half slider widths.

12. The system of claim 8, wherein the second portion is defined as being between the acquire track and the first user track.

13. The system of claim 8, wherein the head is removed from communication with the rotatable medium by positioning the actuator on the ramp.

14. The system of claim 13, wherein the step of positioning the head further comprises loading the head onto the rotatable medium by removing the actuator from contact with the ramp.

15. A media optimized to reduce a density of a plurality of user tracks written to a surface of the media, the media being adapted to be positioned in a data storage device such that a ramp extends over a portion of the surface, the media comprising:
a first portion having a first outer boundary at a first user track and a first inner boundary at an innermost user track;
a second portion having a second inner boundary at a first user track and a second outer boundary nearer an outer diameter than the second inner boundary; and
a plurality of servo wedges to define the plurality of user tracks, the plurality of servo wedges being radially spaced across the first and second portions;
wherein a final user track is written to the second portion.

16. The media of claim 15, wherein system critical information is written to the first portion.

17. The media of claim 15, further comprising:
an acquire track located near the ramp; and
wherein the first user track is located a buffer distance from the acquire track.

18. The media of claim 17, wherein:
a head connected with a slider is positionable on the media; and
the buffer distance is larger than a width of the slider.

19. The media of claim 18, wherein the buffer distance is one-and-a-half widths of the slider.

20. The media of claim 17, wherein the second outer boundary is the acquire track.
